(19) United States
(12) Patent Application Publication
(10) Pub. No.: US 2009/0187304 A1
(43) Pub. Date: Jul. 23, 2009

(54) ELECTRONIC CONTROL MODULE INTEGRATED DIAGNOSTIC FLIGHT RECORDER METHODS AND SYSTEMS

(75) Inventors: Thomas G. Waypa, Hartland, MI (US); Daniel P. Grenn, Highland, MI (US); Joseph M. Stempnik, Warren, MI (US)

Correspondence Address: Harness Dickey & Pierce, P.L.C., P.O. Box 828, Bloomfield Hills, MI, 48303, US

(73) Assignee: GM GLOBAL TECHNOLOGY OPERATIONS, INC., Detroit, MI (US)

(21) Appl. No.: 12/015,799

(22) Filed: Jan. 17, 2008

(51) Int. Cl. G01M 17/00

(52) U.S. Cl. 701/35

(57) ABSTRACT

A control system for a vehicle is provided. The system generally includes a first setup module that configures at least one data recording trigger based on data parameters received from at least one of a telematics system and a technician tool. A data logger module records and stores real-time vehicle data based on the at least one data recording trigger.

### FIELD

The present invention relates to methods and systems for recording real-time data within an electronic control module of a vehicle.

### BACKGROUND

Traditionally, vehicles include multiple systems that regulate overall operation of the vehicle. For example, the vehicle may include an internal combustion engine, an electric machine, and/or a transmission. Each of the components may include an associated control module or modules that communicate with one another to regulate operation of the vehicle.

Each of the control modules operate based on real-time data that is directly sensed from the vehicle or determined from the sensed data. When vehicle faults occur, it is helpful for engineers and technicians to be able to evaluate the real-time data associated with the fault. In production vehicles, access to the real-time data is limited to designated variables that were defined during development of the control module. In some cases, the designated variables may not be helpful to the engineers or technicians. Furthermore, a technician tool must be connected to the vehicle to record the data. The technician tool monitors the communication bus for the designated variables and displays the data for viewing.

### SUMMARY

Accordingly, a control system for a vehicle is provided. The system generally includes a first setup module that configures at least one data recording trigger based on data parameters received from at least one of a telematics system and a technician tool. A data logger module records and stores real-time vehicle data based on the at least one data recording trigger.

In other features, a method of recording real-time vehicle data is provided. The method includes: receiving data parameters from at least one of a telematics system and a technician tool; configuring at least one data recording trigger based on the data parameters; and recording and storing real-time vehicle data based on the at least one data recording trigger.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a functional block diagram of an exemplary vehicle that includes an integrated diagnostic flight recorder according to various aspects of the present disclosure.

FIG. 2 is a dataflow diagram illustrating an exemplary integrated diagnostic flight recording system according to various aspects of the present disclosure.

FIG. 3 is a block diagram illustrating exemplary data triggers of the integrated diagnostic flight recording system according to various aspects of the present disclosure.

FIG. 4 is a block diagram illustrating exemplary overwrite parameters of the integrated diagnostic flight recording system according to various aspects of the present disclosure.

FIG. 5 is a block diagram illustrating an exemplary buffer and datastore of the integrated diagnostic flight recording system according to various aspects of the present disclosure.

FIG. 6 is a flowchart illustrating an exemplary flight recording method that can be performed by the integrated diagnostic flight recording system according to various aspects of the present disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

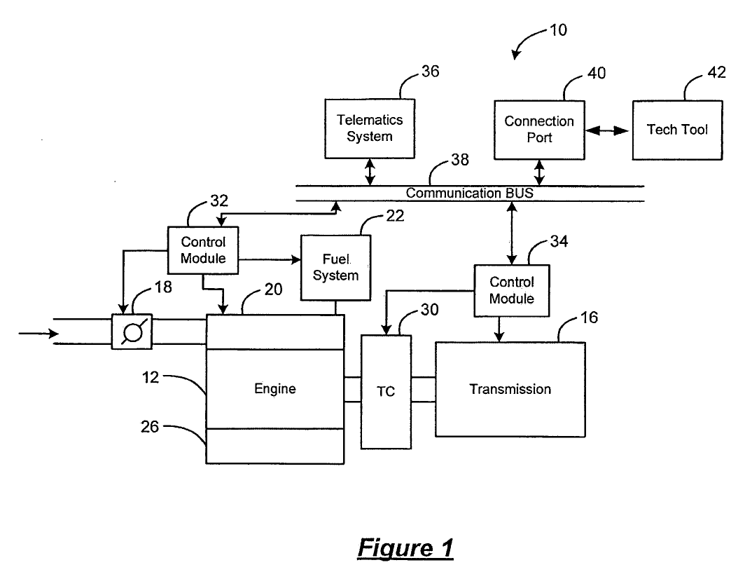

Referring now to FIG. 1, an exemplary vehicle 10 includes an engine 12, which drives a transmission 16. Air is drawn into the engine 12 through a throttle 18 and an intake manifold 20, and is mixed with fuel inside the engine 12. The fuel is delivered by a fuel system 22. The air and fuel mixture is combusted within cylinders (not shown) to generate drive torque. The gases produced via combustion exit the engine 12 through an exhaust manifold 26.

The transmission 16 can include, but is not limited to, a CVT, a manual transmission, an automatic transmission and an automated manual transmission (AMT). Drive torque is transferred from the engine 12 to the transmission 16 through a coupling device 30 such as, for example, a friction clutch or a torque converter. The transmission 16 multiplies the drive torque through one of a plurality of gear ratios.

One or more control modules 32, 34 regulate operation of one or more components of the vehicle 10 and are configured with an integrated diagnostic flight recording (IDFR) system in accordance with various aspects of the present disclosure. For example, an engine control module 32 controls the engine 12 and a transmission control module 34 controls the transmission 16. Each control module 32, 34 includes an IDFR system as will be discussed further below. Real-time data recorded by the IDFR system in each control module 32, 34 can be communicated to a telematics system 36 of the vehicle 10 via a communication bus 38. The telematics system 36 transmits information from the IDFR system to a remote location for further analysis. The real-time data recorded by the IDFR system in each control module 32, 34 can additionally or alternatively be retrieved via a technician tool 42 connected to a communication port 40 (i.e. ALDL connection port) of the vehicle 10.

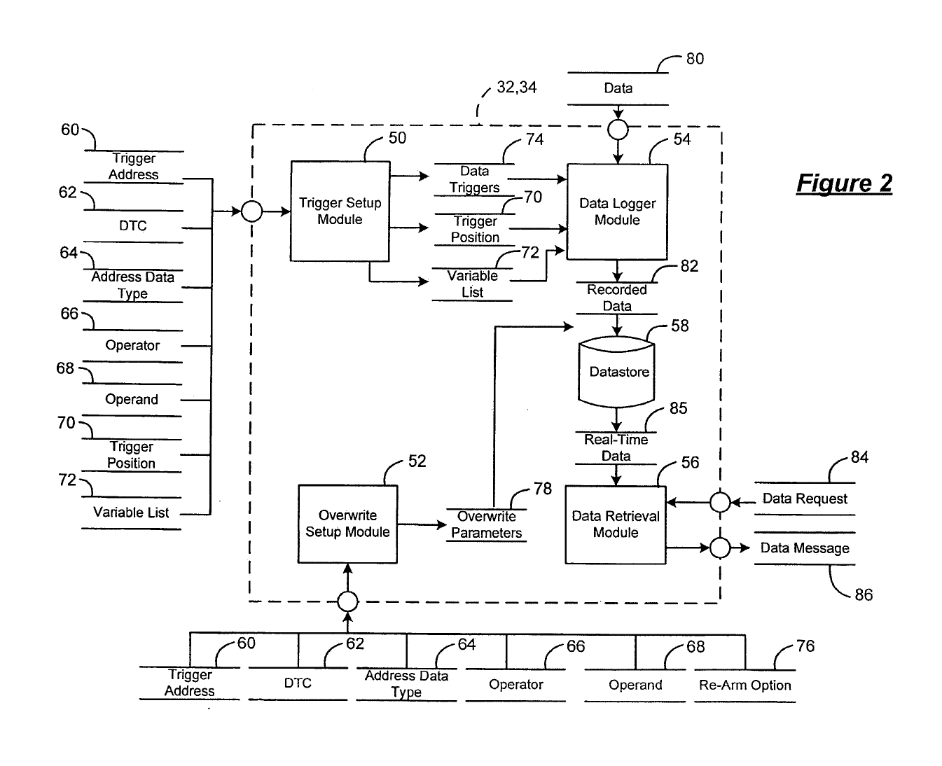

Referring now to FIG. 2, a dataflow diagram illustrates various embodiments of an IDFR system that may be embedded within one or more of the control modules 32, 34. Various embodiments of IDFR systems according to the present disclosure may include any number of sub-modules embedded within the control module 32, 34. As can be appreciated, the sub-modules shown may be combined and/or further partitioned to similarly record and transmit real-time operation data. Inputs to the system may be sensed from the vehicle 10 (FIG. 1), received from other control modules (not shown) within the vehicle 10 (FIG. 1), and/or determined by other sub-modules (not shown) within the control module 32, 34. In various embodiments, the control module 32, 34 of FIG. 2 includes a trigger setup module 50, an overwrite setup module 52, a data logger module 54, a data retrieval module 56, and a datastore 58.

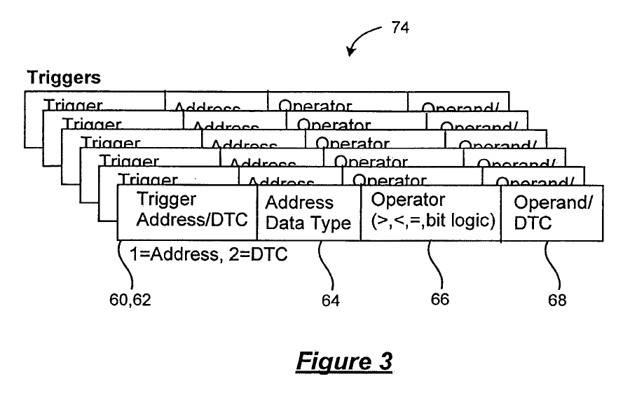

The trigger setup module 50 receives as input a trigger address 60, a diagnostic trouble code (DTC) 62, an address data type 64, an operator 66, an operand 68, a trigger position 70, a variable list 72 and/or combinations thereof. The inputs 60-72 can be configured by, for example, an engineer or technician via the technician tool 42 or the telematics system 36 (FIG. 1). Based on the inputs 60-72, the trigger setup module 50 configures one or more data triggers 74 that specify which data to record and the conditions for initiating recording of the data. At least two classes of data triggers 74 can be defined. For example, a DTC specific class enables a snapshot of defined variables to be recorded at the time the DTC is activated. The data trigger 74 for the DTC specific class can be defined by the DTC 62 and the variable list 72. A triggered class enables defined variables to be collected in a buffer until a trigger event occurs. Once the trigger event occurs at the appropriate trigger position 70, the collected values are stored in memory. The data trigger for the triggered class can be based on DTC activity or a variable value and be defined by the trigger address 60 or-the DTC 62, the address data type 64, the operator 66, and the operand 68 as shown in FIG. 3.

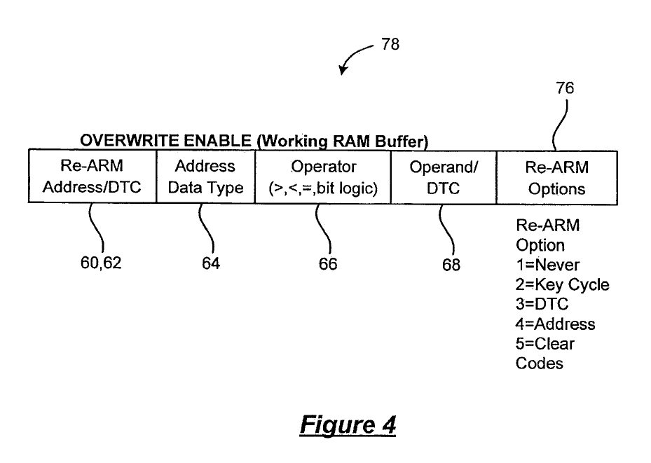

The overwrite setup module 52 receives as input the trigger address 60, the DTC 62, the address data type 64, the operator 66, the operand 68, a re-arm option 76, and/or combinations thereof. The inputs 60-68 and 76 can be configured by, for example, an engineer or technician via the technician tool 42 or the telematics system 36 (FIG. 1). Based on the inputs 60-68 and 76, the overwrite setup module 52 configures overwrite parameters 78 that correspond to the one or more data triggers 74. The overwrite parameters 78 specify the conditions for allowing the stored data to be overwritten by recording new data. For example, as shown in FIG. 4, each overwrite parameter can include the trigger address 60 or DTC 62, the address data type 64, the operator 66, the operand 68, and the associated re-arm option 76. In various embodiments, the re-arm option 76 can be an enumeration with values assigned to re-arm options, such as, ‘never,’ ‘every key cycle,’ ‘after clearing a DTC, ‘based on an address,’ or ‘after a clear code event.’

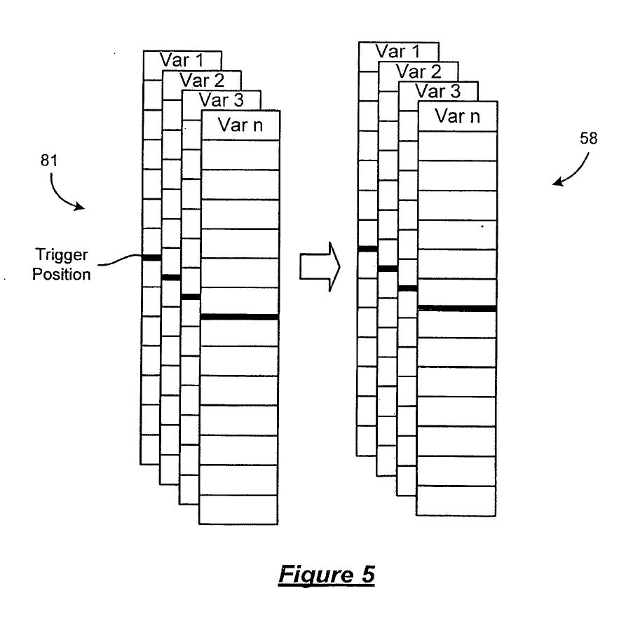

The data logger module 54 receives as input the trigger position 70, the variable list 72, the data triggers 74, the overwrite parameters 78, and real-time data 80. The data logger module 54 initiates recording of the real-time data 80 based on the data triggers 74. For example, if the data trigger 74 corresponds to a DTC specific class, the data logger module 74 records a snapshot of real-time data 74 corresponding to the variable list 72. In various embodiments, the variable list 72 is retrieved via a pointer to the list. In another example, if the data trigger 74 corresponds to a triggered class, the data logger module 54 continually records real-time data 80 corresponding to the variable list 72 in a circular memory buffer 81 as shown in FIG. 5 until the trigger condition is met. The data logger module 54 can record the real-time data based on the trigger position 70. For example, if the trigger position 70 is configured to ‘pre-trigger,’ the data prior to the trigger event is recorded. If the trigger position is configured to ‘post-trigger’ the data after the trigger event is recorded. If the trigger position is set to ‘center trigger,’ the data equally before and after the trigger event is recorded as shown in FIG. 5. The overall memory buffer size can be fixed. The buffer size per variable can be dynamic.

Once recorded, the data logger module 54 stores the recorded data 82 in the datastore 58. The activation of the storage can be based on a certain event such as, for example, upon key off of the vehicle 10 (FIG. 1). In various embodiments, the datastore 58 is non-volatile memory that allows the recorded data 82 to remain stored when power is removed from the control module 32, 34. Once the recorded data 82 is stored, the data logger module 54 overwrites the stored data based on the overwrite parameters 78.

The data retrieval module 56 receives as input a data request 84. Based on the data request 84, the data retrieval module 56 retrieves the stored data 85 from the datastore 58 and communicates the data in the appropriate message form 86 to the entity generating the data request 84 such as the telematics system 36 or the technician tool 42 (FIG. 1).

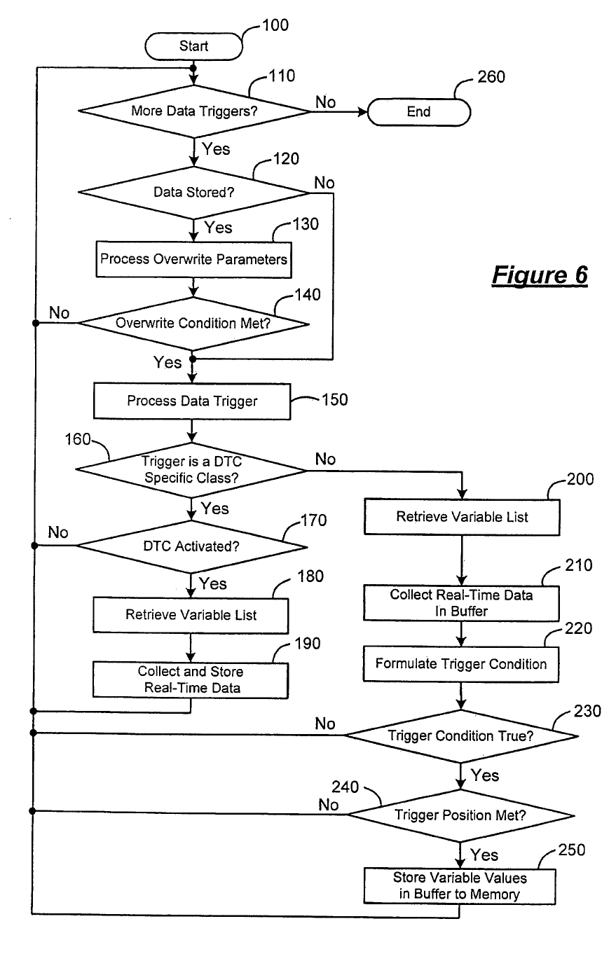

Referring now to FIG. 6, a flowchart illustrates an exemplary IFDR method that can be performed by the data logger module 54 of the IFDR system of FIG. 2 in accordance with various aspects of the present disclosure. As can be appreciated, the order of execution of the steps of the IFDR method can vary without altering the spirit of the method. The method may be scheduled to be performed periodically during control module operation or scheduled to run based on certain events.

In one example, the method may begin at 100. The method is performed for each data trigger 74 defined. If there is a data trigger 74 to be processed at 110, it is determined whether the real-time data 80 has already been stored at 120. If the real-time data 80 has already been stored at 120, the overwrite parameters 78 are processed to formulate an overwrite condition at 130 and the overwrite condition is evaluated at 140. If the overwrite condition is met at 140, the data trigger 74 is processed at 150 and evaluated at 160. Otherwise, if the overwrite condition is not met at 140, the method proceeds to evaluate whether there is a next data trigger 74 at 110.

If the real-time data 80 has not already been stored at 120 the data trigger 74 is processed at 150 and evaluated at 160. If the data trigger 74 is defined as a DTC specific class at 160, the designated DTC 62 is evaluated at 170. If the DTC 62 is activated at 170, the designated variable list 72 is retrieved at 180 and the real-time data 80 corresponding to the variables of the variable list 72 is recorded and stored in the datastore 58 at 190. Otherwise, if the DTC 62 is not activated at 170 the method proceeds to evaluate whether there is a next data trigger 74 at 110.

However, if the data trigger 74 is not defined as a DTC specific class, rather a triggered class at 160, the variables of the variable list 72 is recorded in the buffer 81 (FIG. 5) at 210. The trigger condition for the data trigger 74 is formulated at 220 and evaluated at 230. If the trigger condition for the data trigger 74 is met at 230, the trigger position 70 is evaluated at 240. Otherwise, if the trigger condition for the data trigger 74 is not met at 230, the method proceeds to evaluate whether there is a next data trigger 74 at 110. If, at 240, the trigger position 70 is met, the variable values recorded in the buffer 81 (FIG. 5) are stored in the datastore 58 at 250. Otherwise, if that trigger position 70 is not met at 250, the method proceeds to evaluate whether there is a next data trigger 74 at 110. Once there are no more data triggers 74 to be evaluated at 110, the method may end at 260.

Those skilled in the art can now appreciate from the foregoing description that the broad teachings of the present disclosure can be implemented in a variety of forms. Therefore, while this disclosure has been described in connection with particular examples thereof, the true scope of the disclosure should not be so limited since other modifications will become apparent to the skilled practitioner upon a study of the drawings, specification, and the following claims.

What is claimed is:

1. A control system for a vehicle, comprising:
a first setup module that configures at least one data recording trigger based on data parameters received from at least one of a telematics system and a technician tool; and
a data logger module that records and stores real-time vehicle data based on the at least one data recording trigger.

2. The system of claim 1 further comprising a second setup module that configures overwrite parameters that correspond to the at least one data recording trigger and wherein the data logger module overwrites the stored real-time vehicle data based on newly recorded real-time vehicle data and the overwrite parameters.

3. The system of claim 2 wherein the second setup module configures the overwrite parameters based on input parameters received from at least one of a telematics system and a technician tool.

4. The system of claim 1 further comprising a data retrieval module that retrieves the stored real-time vehicle data based on a data request received from at least one of a telematics system and a technician tool.

5. The system of claim 4 wherein the data retrieval module transmits the retrieved real-time vehicle data to the at least one of the telematics system and the technician tool.

6. The system of claim 1 wherein the data recording trigger is defined by at least one of a diagnostic trouble code, a variable address, an address type, an operator, and an operand.

7. The system of claim 1 wherein the data logger module records the real-time vehicle data based on activation of a diagnostic trouble code.

8. The system of claim 1 wherein the data logger module records the real-time vehicle data in a circular buffer until a condition defined by the data recording trigger is met.

9. The system of claim 8 wherein the data logger module records the real-time vehicle data in the circular buffer until a trigger position is met.

10. The system of claim 8 further comprising a datastore that maintains the real-time vehicle data when power is removed from the control system and wherein the data logger module stores the recorded real-time vehicle data in the datastore.

11. A method of recording real-time vehicle data, comprising:
receiving data parameters from at least one of a telematics system and a technician tool;
configuring at least one data recording trigger based on the data parameters; and
recording and storing real-time vehicle data based on the at least one data recording trigger.

12. The method of claim 11 further comprising:
configuring overwrite parameters that correspond to the at least one data recording trigger; and
overwriting the stored real-time vehicle data based on newly recorded real-time vehicle data and the overwrite parameters.

13. The method of claim 12 wherein the configuring the overwrite parameters is based on input parameters received from at least one of a telematics system and a technician tool.

14. The method of claim 11 further comprising retrieving the stored real-time vehicle data based on a data request received from at least one of a telematics system and a technician tool.

15. The method of claim 14 further comprising transmitting the retrieved real-time vehicle data to the at least one of the telematics system and the technician tool.

16. The method of claim 11 further comprising defining the data parameter to be at least one of a diagnostic trouble code, a variable address, an address type, an operator, and an operand.

17. The method of claim 11 wherein the recording the real-time vehicle data is based on activation of a diagnostic trouble code.

18. The method of claim 11 wherein the recording the real-time vehicle data comprises recording the real-time vehicle data in a circular buffer until a condition defined by the data recording trigger is met.

19. The method of claim 18 wherein the recording the real-time vehicle data comprises recording the real-time vehicle data in, the circular buffer until a trigger position is met.

20. The method of claim 18 further comprising maintaining the real-time vehicle data in memory when power is removed from the control system.
